(19) United States
(12) Patent Application Publication
(10) Pub. No.: US 2026/0318128 A1
(43) Pub. Date: Oct. 15, 2026

(54) HANDLE DEVICE FOR VEHICLES

(71) Applicant: ALPHA CORPORATION, Kanagawa (JP)

(72) Inventor: Takao TOYAMA, Kanagawa (JP)

(73) Assignee: ALPHA CORPORATION, Kanagawa (JP)

(21) Appl. No.: 19/691,133

(22) Filed: May 28, 2026

Related U.S. Application Data
(63) Continuation of application No. PCT/JP2024/041739, filed on Nov. 26, 2024.

(30) Foreign Application Priority Data
Nov. 30, 2023 (JP) 2023-202812

(51) Int. Cl. E05B 85/10; E05B 81/06; E05B 85/16

(52) U.S. Cl. CPC E05B 85/107; E05B 81/06; E05B 85/103; E05B 85/16

(57) ABSTRACT

A handle device for vehicles includes: a handle base fixed to a vehicle; and a handle main body connected to the handle base and configured to be pulled out from an initial position. An adjustment member configured to adjust a position of the handle main body at the initial position is assembled to the handle base. The adjustment member adjusts a position of the handle main body at the initial position by changing an abutment position on an abutment portion provided in the handle device when the handle main body is at the initial position.

### CROSS-REFERENCE TO RELATED APPLICATIONS

This is a continuation of International Application No. PCT/JP2024/041739 filed on Nov. 26, 2024, and claims priority from Japanese Patent Application No. 2023-202812 filed on Nov. 30, 2023, the entire content of which is incorporated herein by reference.

### TECHNICAL FIELD

The present disclosure relates to a handle device for vehicles.

### BACKGROUND ART

As a handle device having a handle main body that can be pulled out from an initial position when a door is operated, a handle device described in U.S. Pat. No. 9,103,143B is known.

A so-called pop-up type handle device of the related art including U.S. Pat. No. 9,103,143B includes, for example, a handle main body rotatably connected to one end of an operation lever driven by an electric actuator fixed on a handle base, and an unlocking lever connected to an end opposite to a connection end of the handle main body to the operation lever. When the electric actuator is operated, the handle main body moves from the initial position where the handle main body is positioned on the same surface as a door panel to an operation position where the handle main body is raised from the door panel, and when the handle main body is operated at the operation position, a release operation of a door latch device can be performed.

However, in the handle device described above, the initial position is uniquely determined by a dimensional relationship between components, and when there is a dimension error or the like, there is a possibility that the handle main body is not held on the same surface as the door panel.

### TECHNICAL PROBLEM

The present disclosure relates to a handle device for vehicles in which a positional relationship between a handle main body and a surface of a door panel can be adjusted to a predetermined position even if there is an error between components.

### SUMMARY OF INVENTION

According to the present disclosure, a handle device for vehicles includes a handle base fixed to a vehicle, and a handle main body connected to the handle base and configured to be pulled out from an initial position, in which an adjustment member configured to adjust a position of the handle main body at the initial position is assembled to the handle base, and the adjustment member adjusts a position of the handle main body at the initial position by changing an abutment position on an abutment portion provided in the handle device when the handle main body is at the initial position.

The handle main body may constitute a link mechanism in cooperation with the handle base serving as a fixed link, and the abutment portion may be provided on any movable link including the handle main body of the link mechanism.

The adjustment member may be assembled to the handle base so as to be displaceable in a direction intersecting a pull-out direction of the handle main body.

The abutment portion may be formed in a stepped shape having different heights in the pull-out direction.

The adjustment member may be an impact absorbing member that abuts against the handle main body to absorb an impact when the handle main body returns from a pop-up position pulled out from the initial position to the initial position.

### ADVANTAGEOUS EFFECTS OF INVENTION

According to the present disclosure, it is possible to provide a handle device for vehicles in which a positional relationship between the handle main body and the surface of the door panel can be adjusted to a predetermined position even if there is an error between components.

### BRIEF DESCRIPTION OF DRAWINGS

FIG. 1 is a front view illustrating a handle device for vehicles according to an embodiment of the present disclosure.

FIG. 2 is a back view of the handle device for vehicles illustrated in FIG. 1.

FIG. 3 is a cross-sectional view taken along a line X3-X3 of FIG. 2.

FIG. 4A is an enlarged view of a portion X1 in FIG. 2.

FIG. 4B is an enlarged view of a portion X2 in FIG. 2.

FIG. 5 is a cross-sectional view taken along a line X4-X4 of FIG. 2.

FIG. 6 is a view illustrating an operation of the handle device for vehicles illustrated in FIG. 1.

FIG. 7 is a view illustrating an operation of the handle device for vehicles illustrated in FIG. 1.

FIG. 8 is a table summarizing examples of bumper rubber assembly depending on each state of a relative position of a handle main body relative to a door surface at an initial position.

### DESCRIPTION OF EMBODIMENTS

A specific embodiment of the present disclosure will be described below with reference to the drawings.

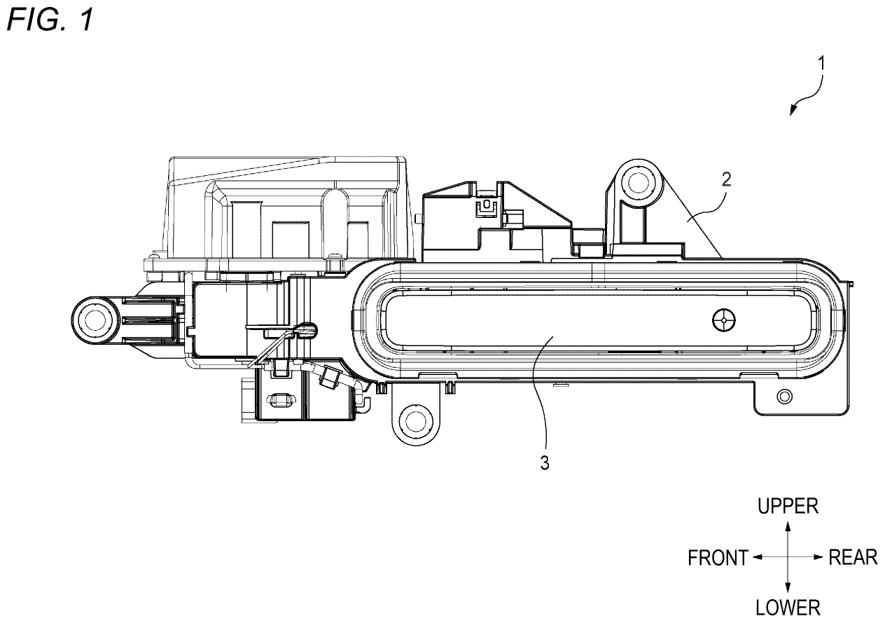

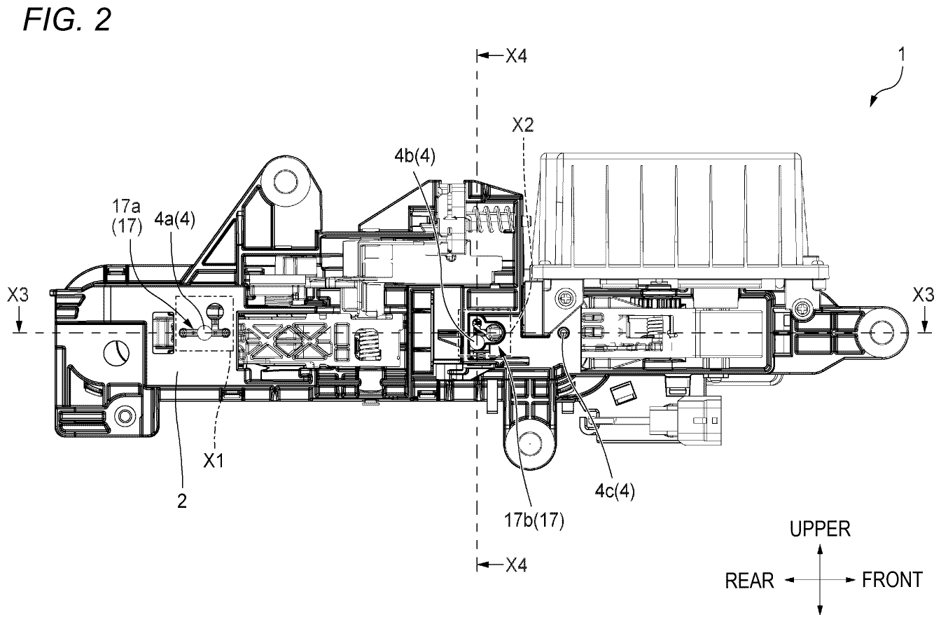

Hereinafter, for convenience of description, as illustrated in FIG. 1, “front”, “rear”, “left”, “right”, “upper”, and “lower” are defined. A “front-rear direction”, a “left-right direction”, and an “upper-lower direction” are orthogonal to each other. The left-right direction corresponds to a “pull-out direction” of the present disclosure. The front-rear direction and the upper-lower direction correspond to an “intersecting direction” of the present disclosure.

Here, for example, each direction described above may correspond to each direction when a handle device 1 is mounted on a vehicle. In this case, the handle device 1 illustrated in FIG. 1 and the like is a handle device mounted on a left side of the vehicle. However, the handle device on the left side and a handle device on a right side have the same configuration except that arrangement in the left-right direction is opposite to each other and rotation operations thereof are reversed.

As illustrated in FIG. 1, the handle device 1 includes a handle base 2, a handle main body 3, and a first link 11 and a second link 12 that connect the handle main body 3 to the handle base 2, and is fixed to a door of a vehicle at the handle base 2.

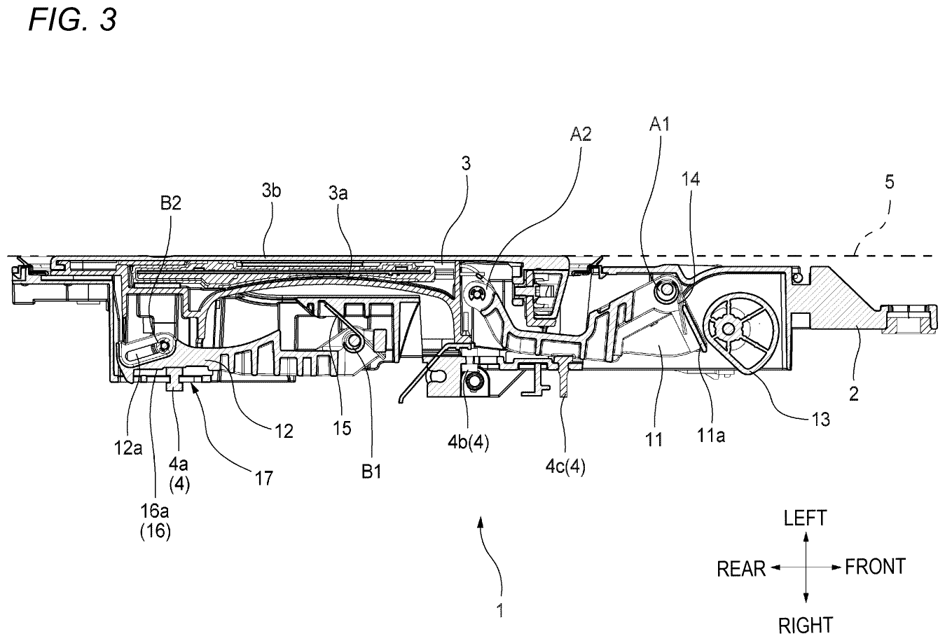

The handle main body 3 is formed with a handhold portion 3a serving as a handhold at the time of door operation in a central portion in the front-rear direction, and a surface 3b is substantially flush with a door surface 5 (door panel) in a state where the handle base 2 is fixed to the door (see FIG. 3).

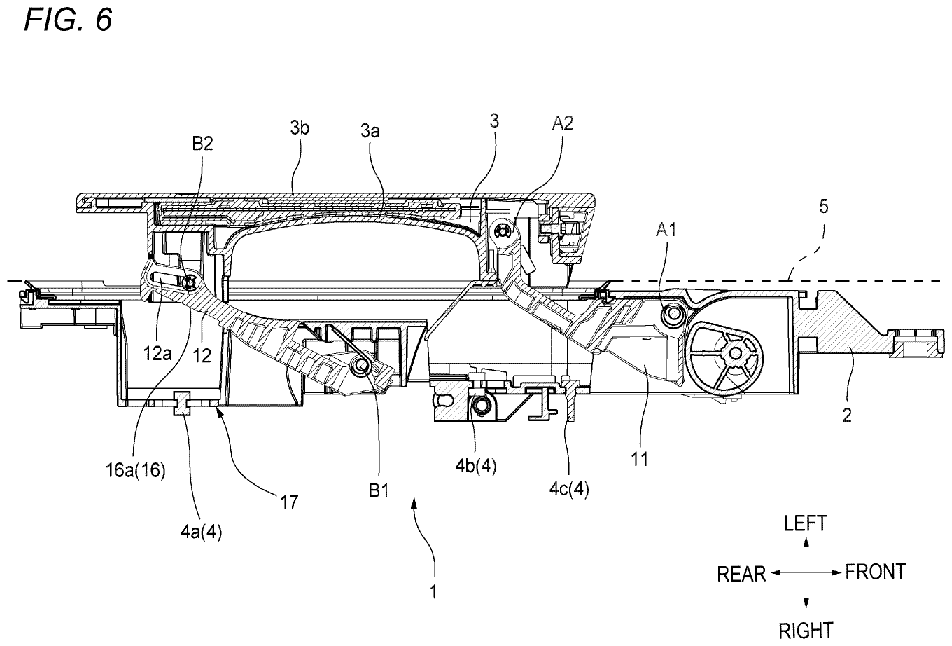

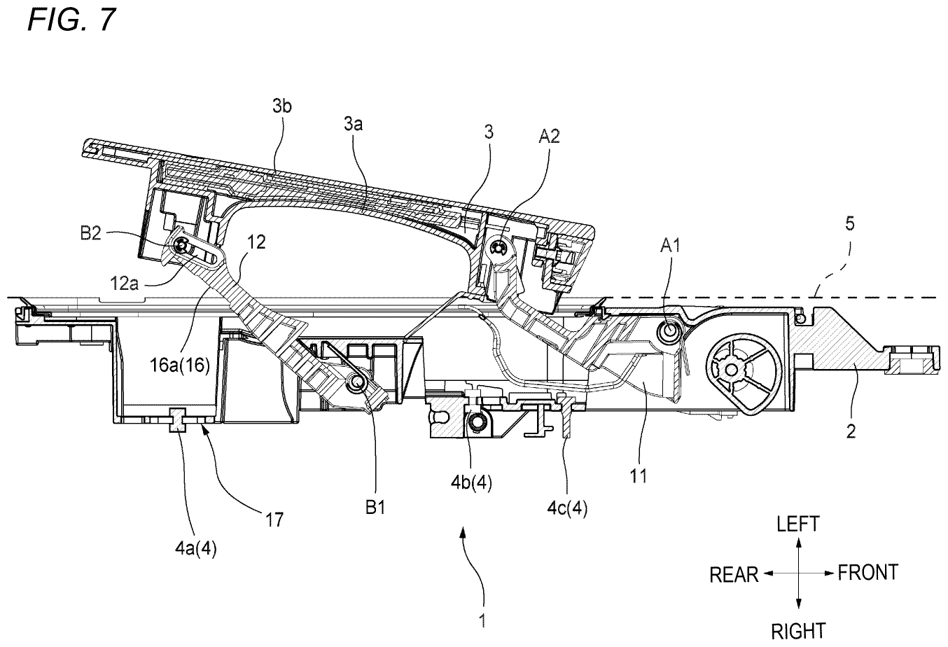

The handle main body 3 can be moved among the initial position (see FIG. 3) in which the handhold portion 3a is accommodated in the door, a pop-up position (see FIG. 6) in which the handhold portion 3a pops out from the door panel and the handle main body 3 can be operated by placing a hand on the handhold portion 3a, and a latch operation position (see FIG. 7) in which one end (in this example, a rear end) of the handle main body 3 is pulled up from the pop-up position.

A driven portion 11a of the first link 11 is pressed against a cam member 13 that is rotationally driven by a motor (not illustrated), and the first link 11 is driven to rotate about a connecting shaft (A1) to the handle base 2. In order to maintain a pressure contact state between the driven portion 11a and the cam member 13, a counterclockwise rotational moment is applied to the first link 11 by a torsion spring 14.

An end of the first link 11 opposite to a connection end of the first link 11 to the handle base 2 is rotatably connected to one end of the handle main body 3 about a connecting shaft (A1).

One end of the second link 12 is rotatably connected to the handle base 2 about a connecting shaft (B1). A long hole 12a is formed at an opposite end of the second link 12, and a connecting shaft (B2) fixed to the other end of the handle main body 3 is rotatably and slidably inserted.

Therefore, component members of the handle device 1 constitute a five-node link mechanism (see FIGS. 3 and 6 to 7) having the handle base 2 as a fixed link, the first link 11 and the second link 12 connected to the fixed link by revolute pairs at intervals between the connecting shafts (A1, B1), a slider (the long hole 12a) connected to the second link 12 by a sliding pair, and the handle main body 3 having both ends connected to the first link 11 and the slider in a revolute pair, as elements.

A sliding stroke end of the slider sliding on the second link 12 is determined in advance as an end position of the long hole 12a, and in addition to the rotational moment applied to the first link 11 described above, a counterclockwise rotational moment is applied to the second link 12 by a torsion spring 15, whereby the slider is held at a stroke end position on the connecting shaft (B1) side of the second link 12 to the handle base 2.

Since link lengths of the fixed link and the handle main body 3 are equal to each other, and a distance (distance between B1 and B2 in FIG. 3) between the slider at the stroke end position and the connecting shaft (B1) of the fixed link of the second link 12 is equal to a link length of the first link 11, when an electric rotation operation is performed using the first link 11 as a drive link, the handle device substantially operates as a parallel link of four nodes.

Therefore, when the first link 11 is rotated clockwise from an initial state (see FIG. 3) in which the surface 3b of the handle main body 3 is substantially flush with the door panel (door surface 5), the handle main body 3 moves in parallel to the pop-up position (see FIG. 6).

From this state, when the handle main body 3 is manually rotated clockwise to the latch operation position (see FIG. 7), since the clockwise rotation of the first link 11 around the connecting shaft (A1) with the handle base 2 is restricted by the motor, a slider crank mechanism substantially using the handle main body 3, the second link 12, and the slider as movable links is operated when the handle main body 3 is rotated in the above direction, and the second link 12 further rotates by a predetermined angle from the state of FIG. 6.

On the other hand, the handle base 2 is provided with a latch operation mechanism (not illustrated) which operates by the rotation of the second link 12 around the connecting shaft (B1) with the handle base 2 from FIG. 6 to FIG. 7, and the latch operation mechanism releases a door latch device fixed to the door through an appropriate transmission means such as a cable device in accordance with the rotation of the handle main body 3 to an operation position.

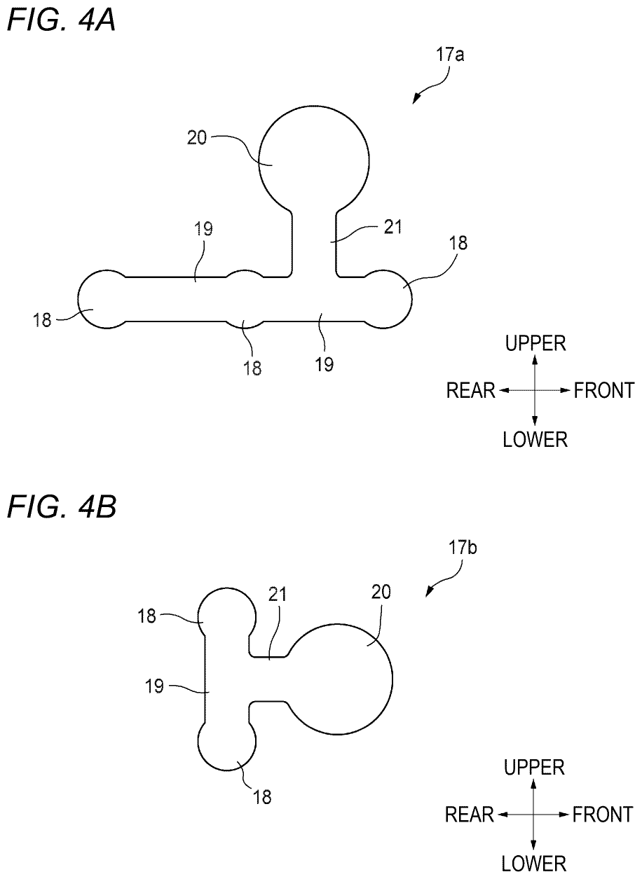

A bumper rubber 4 for adjusting the position of the handle main body 3 at the initial position is assembled to the handle base 2. The bumper rubber 4 is a known bumper rubber that abuts against an abutment portion 16 to absorb an impact when the handle main body 3 returns from the pop-up position (see FIG. 6) to the initial position (see FIG. 3). The bumper rubber 4 has a so-called substantially gourd shape, and is held at a recessed portion at a center by a holding portion 18 (see FIGS. 4A and 4B) of an assembled portion 17 in the handle base 2.

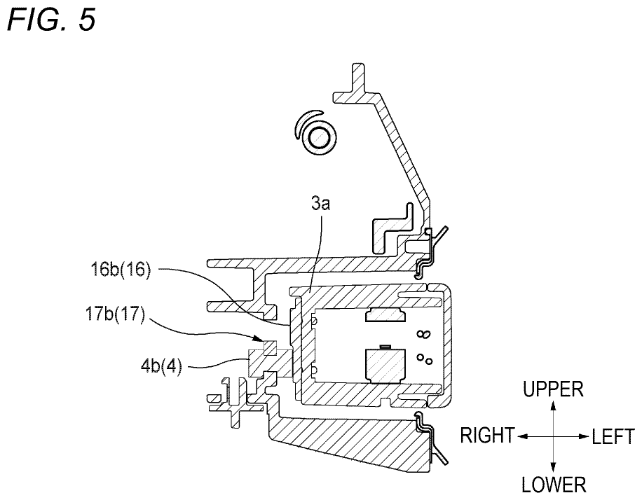

In the handle device 1, the bumper rubber 4 includes a bumper rubber 4a that abuts against an abutment portion 16a (see FIGS. 3 and 6 to 7) formed at a right end of the second link 12 in a rear region of the handle main body 3, and at least one of a bumper rubber 4b that abuts against an abutment portion 16b (see FIG. 5) formed at a front right end of the handhold portion 3a and a bumper rubber 4c that abuts against the abutment portion (not illustrated) formed at a right end of the first link 11, in a front region of the handle main body 3.

The abutment portion 16a is formed in a stepped shape having different protrusion heights to the right in the front-rear direction (three steps in the present example, see FIGS. 3 and 6 to 7), the bumper rubber 4 a is held by any one of a plurality of (three in the present example) holding portions 18 arranged side by side at intervals in the front-rear direction, and when a position of the handle main body 3 at the initial position is adjusted, the bumper rubber 4a passes through a guide portion 19 (see FIG. 4A) that connects adjacent holding portions 18 (see FIG. 4A) in the front-rear direction and is moved to the other holding portion 18. The bumper rubber 4a is inserted into the assembled portion 17a from an assembling hole 20 having a diameter larger than an outer dimension of the bumper rubber 4a, passes through a connecting portion 21 connecting the guide portion 19 and the assembling hole 20 and the guide portion 19 in this order, and is held by the holding portion 18.

The abutment portion 16b is formed in a stepped shape having different protrusion heights to the right in the upper-lower direction (two steps in the present example, see FIG. 5), the bumper rubber 4b is held by one of a plurality of (two in the present example) holding portions 18 arranged side by side at intervals in the upper-lower direction, and when the position of the handle main body 3 at the initial position is adjusted, the bumper rubber 4b passes through the guide portion 19 (see FIG. 4B) that connects adjacent holding portions 18 (see FIG. 4B) in the upper-lower direction and is moved to the other holding portion 18. The bumper rubber 4b is inserted into the assembled portion 17b from the assembling hole 20 having a diameter larger than an outer dimension of the bumper rubber 4b, passes through the connecting portion 21 connecting the guide portion 19 and the assembling hole 20 and the guide portion 19 in this order, and is held by the holding portion 18.

The abutment portion 16a is formed in a three-step shape, whereas the abutment portion 16b is formed in a two-step shape. That is, the bumper rubber 4a can be adjusted in three stages, whereas the bumper rubber 4b is adjusted only in two stages. Therefore, the bumper rubber 4 includes the bumper rubber 4c.

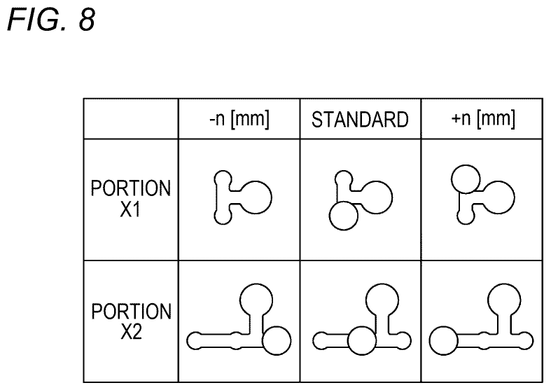

Specifically, as illustrated in FIG. 8, in the initial state of the handle main body 3, in a standard state where the surface 3b of the handle main body 3 is substantially flush with the door panel (the door surface 5), the bumper rubber 4a is held by the holding portion 18 at the center in the assembled portion 17a, and the bumper rubber 4b is held by the holding portion 18 on a lower side in the assembled portion 17b. Thus, the bumper rubber 4a abuts against a central end surface of the stepped abutment portion 16a, and the bumper rubber 4b abuts against a lower end surface of the stepped abutment portion 16b.

In the initial state of the handle main body 3, in a state where the surface 3b of the handle main body 3 is located on the right side of the door panel (the door surface 5), that is, in the door panel, the bumper rubber 4a is held by the holding portion 18 on a rear side in the assembled portion 17a, and the bumper rubber 4b is held by the holding portion 18 on an upper side in the assembled portion 17b. Thus, the bumper rubber 4a abuts against a rear end surface of the stepped abutment portion 16a, and the bumper rubber 4b abuts against an upper end surface of the stepped abutment portion 16b.

In the initial state of the handle main body 3, in a state where the surface 3b of the handle main body 3 is on the left side of the door panel (the door surface 5), that is, pops out from the door panel, the bumper rubber 4a is held by the holding portion 18 on the front side in the assembled portion 17a, and the bumper rubber 4b is not assembled to the assembled portion 17b. The bumper rubber 4a abuts against a front end surface of the stepped abutment portion 16a, and the bumper rubber 4c abuts against an abutment portion (not illustrated) instead of the bumper rubber 4b.

In the initial state of the handle main body 3, only one side in the front-rear direction may enter the door panel or may pop out from the door panel, and in this case, the bumper rubbers 4a, 4b, and 4c may be appropriately set as described above.

The bumper rubbers 4a, 4b are displaceable in the respective directions (a movement from one holding portion 18 to the other holding portion 18), for example, by inserting a jig or the like from below the handhold portion 3a and operating the jig or the like when the handle main body 3 is at the pop-up position in a state where the handle device 1 is fixed in the door.

As described above, in the handle device 1, by displacing the bumper rubbers 4a, 4b in the respective directions, abutment positions with the abutment portions 16a, 16b formed in a stepped shape are changed (that is, the bumper rubbers 4a, 4b abut against the end surfaces having different protrusion heights to the right), and thus the position of the handle main body 3 at the initial position is adjusted.

As described above, according to the present embodiment, when the handle main body 3 is at the initial position, the position of the handle main body 3 at the initial position is adjusted by changing the abutment position between the bumper rubber 4 assembled to the handle base 2 and the abutment portion 16 provided in the handle device 1. That is, according to the present embodiment, a relative position of the handle main body 3 relative to the door surface 5 at the initial position can be adjusted by changing the abutment position between the bumper rubber 4 and the abutment portion 16. As a result, according to the present embodiment, even when the relative position of the handle main body 3 relative to the door panel is shifted at the initial position due to an error in an attachment position or the components, the handle main body 3 can be adjusted to a predetermined position.

According to the present embodiment, since the abutment portion 16 is provided on any of the movable links (in this example, the handle main body 3 and the second link 12) including the handle main body 3 of the link mechanism, the relative position of the handle main body 3 relative to the door surface 5 at the initial position can be more appropriately adjusted.

According to the present embodiment, since the bumper rubber 4 is assembled to the handle base 2 so as to be displaceable in the front-rear direction or the upper-lower direction, the adjustment of the abutment position is facilitated.

According to the present embodiment, since the height of the abutment portion 16 in the left-right direction is formed in different stepped shapes, the abutment position can be easily adjusted with a simple structure.

According to the present embodiment, since the relative position of the handle main body relative to the door surface at the initial position can be adjusted by utilizing the bumper rubber 4, an increase in the number of components can be reduced.

According to the present embodiment, since the bumper rubber 4a is disposed in the rear region of the handle main body 3 and at least one of the bumper rubber 4b and the bumper rubber 4c is disposed in the front region of the handle main body 3, the relative position of the handle main body 3 relative to the door surface 5 at the initial position can be more appropriately adjusted. Specifically, in the initial state of the handle main body 3, only one side in the front-rear direction may enter the door panel or may pop out from the door panel, but by disposing the bumper rubber 4 as described above, the surface 3b of the handle main body 3 can be kept parallel to the door panel (the door surface 5) and becomes substantially flush with the door panel.

The present invention is not limited to the embodiment described above, and modifications, improvements, and the like can be made as appropriate. In addition, materials, shapes, dimensions, numbers, arrangement positions, and the like of the constituent elements in the embodiment described above are optional and are not limited as long as the present disclosure can be achieved.

A handle device (1) for vehicles according to the present disclosure including:
a handle base (2) fixed to a vehicle; and
a handle main body (3) connected to the handle base (2) and configured to be pulled out from an initial position, in which
an adjustment member (the bumper rubber 4) configured to adjust a position of the handle main body (3) at the initial position is assembled to the handle base (2), and
the adjustment member (the bumper rubber 4) adjusts a position of the handle main body (3) at the initial position by changing an abutment position on an abutment portion (16) provided in the handle device (1) when the handle main body (3) is at the initial position.

According to this configuration, when the handle main body is at the initial position, the position of the handle main body at the initial position is adjusted by changing the abutment position between the adjustment member assembled to the handle base and the abutment portion provided in the handle device. In general, at the initial position of the handle device, the surface of the handle main body needs to occupy a predetermined relative position with respect to the door surface (door panel) in order to meet design requirements and the like. That is, according to the present disclosure, the relative position of the handle main body relative to the door surface at the initial position can be adjusted by changing the abutment position between the adjustment member and the abutment portion. As a result, even when the relative position of the handle main body relative to the door panel is shifted at the initial position due to an error in an attachment position or the components, the handle main body can be adjusted to a predetermined position.

In the handle device (1) for vehicles,
the handle main body (3) constitutes a link mechanism in cooperation with the handle base (2) serving as a fixed link, and
the abutment portion (16) is provided on any movable link (the first link 11) including the handle main body (3) of the link mechanism.

According to this configuration, since the abutment portion is provided on any movable link including the handle main body of the link mechanism, the relative position of the handle main body relative to the door surface at the initial position can be more appropriately adjusted.

The adjustment member (the bumper rubber 4) may be assembled to the handle base (2) so as to be displaceable in a direction intersecting with a pull-out direction of the handle main body (3).

According to this configuration, since the adjustment member is assembled to the handle base so as to be displaceable in the direction intersecting with the pull-out direction of the handle main body, the adjustment of the abutment position is facilitated.

The abutment portion (16) may be formed in a stepped shape having different heights in the pull-out direction.

According to this configuration, since the abutment portion is formed in a stepped shape having different heights in the pull-out direction, the abutment position can be easily adjusted with a simple structure.

The adjustment member (the bumper rubber 4) may be an impact absorbing member that abuts against the handle main body (3) to absorb an impact when the handle main body (3) returns from a pop-up position pulled out from the initial position to the initial position.

According to this configuration, since the adjustment member is the impact absorbing member (for example, the bumper rubber) that abuts against the handle main body to absorb an impact when the handle main body returns from the pop-up position to the initial position, the impact absorbing member provided in the handle device of the related art can be used. That is, according to the present disclosure, the relative position of the handle main body relative to the door surface at the initial position can be adjusted without increasing the number of components.

Although various embodiments have been described above, it is needless to say that the present disclosure is not limited to such embodiments. It is apparent to those skilled in the art that various variations or modifications can be conceived within the scope described in the claims, and it is understood that the variations or modifications naturally fall within the technical scope of the present disclosure. Further, the constituent elements described in the above embodiment may be freely combined without departing from the spirit of the invention.

What is claimed is:

1. A handle device for vehicles comprising:
a handle base fixed to a vehicle; and
a handle main body connected to the handle base and configured to be pulled out from an initial position,
wherein an adjustment member configured to adjust a position of the handle main body at the initial position is assembled to the handle base, and
wherein the adjustment member adjusts a position of the handle main body at the initial position by changing an abutment position on an abutment portion provided in the handle device when the handle main body is at the initial position.

2. The handle device for vehicles according to claim 1,
wherein the handle main body constitutes a link mechanism in cooperation with the handle base serving as a fixed link, and
wherein the abutment portion is provided on any movable link including the handle main body of the link mechanism.

3. The handle device for vehicles according to claim 1,
wherein the adjustment member is assembled to the handle base so as to be displaceable in a direction intersecting with a pull-out direction of the handle main body.

4. The handle device for vehicles according to claim 1,
wherein the abutment portion is formed in a stepped shape having different heights in the pull-out direction.

5. The handle device for vehicles according to claim 1,
wherein the adjustment member is an impact absorbing member that abuts against the handle main body to absorb an impact when the handle main body returns from a pop-up position pulled out from the initial position to the initial position.
